(19) United States
(12) Patent Application Publication
(10) Pub. No.: US 2009/0005973 A1
(43) Pub. Date: Jan. 1, 2009

(54) SPONSORED LANDMARKS IN NAVIGATION, COUPONING, PARALLEL ROUTE CALCULATION

(76) Inventors: Juha Heikki SALO, Littoinen (FI); Ari Antero Aarnio, Espoo (FI)

Correspondence Address: MORGAN & FINNEGAN, L.L.P., 3 WORLD FINANCIAL CENTER, NEW YORK, NY, 10281-2101, US

(21) Appl. No.: 11/770,391

(22) Filed: Jun. 28, 2007

(51) Int. Cl. G01C 21/30

(52) U.S. Cl. 701/209; 701/213; 705/14

(57) ABSTRACT

A method, apparatus, and computer program product pre-calculate navigational routes to points of interest on a digital map so that route directions to a selected point of interest can be presented immediately when the user makes the selection while in motion and coupons and special offers can be provided related to those points of interest. In parallel with motion along a principal direction, the navigation device pre-calculates routes to points of interest before they become visible within the viewport of the device, so that the pre-calculated routes can be presented immediately if the user selects the point of interest.

### TECHNICAL FIELD

The technical field broadly relates to advertising, navigation, and promotional offerings involving coupons and more particularly relates to improvements in a mobile communicator for calculating and maintaining routes to points of interest on a digital map and providing coupons and special offers related to those points of interest.

### BACKGROUND

Landmark-based navigation is a concept where navigation instructions are associated with well known (branded) landmarks, such as shopping centers, hotels, gas stations and the like located along a principal highway. Coupons and special offers, especially with branded landmarks, can be made to consumers driving along the principal highway (also known as couponing.)

Regarding sponsored landmarks with e.g. coupons associated with gas stations, the following problems exist:
A new route calculation takes time, at least several seconds.
A vehicle moves quickly, at least 10 meters per second in a city environment.
If the consumer opts in to get “a coupon for gas rebate at Chevron”, she probably wants to use it right away, requiring an immediate change of route.
However, since the vehicle moves quickly, there is high probability that the consumer has already passed a crucial intersection when new route information becomes available.

The problem is how to rapidly present to a driver in a fast moving vehicle, instructions for a driving route to a point of interest before the street leading to the point of interest is passed and how to provide coupons and special offers related to that points of interest.

### SUMMARY

A method, apparatus, and computer program product pre-calculate navigational routes to points of interest on a digital map so that route directions to a selected point of interest can be presented immediately when the user makes the selection while in motion. In parallel with motion along a principal direction, the navigation device pre-calculates routes to points of interest before they become visible within the viewport of the device, so that the pre-calculated routes can be presented immediately if the user selects the point of interest.

In one embodiment, the navigation device can include a coupon database for points of interest, for storing offer/coupon metadata accessible by geo-coordinate values for each respective point of interest. The offer/coupon metadata can include promotional coupons and other promotional messages, navigational information, and displayable icons for the point of interest. The navigation device can include a global positioning system (GPS) module for obtaining a current location of the navigation device during the device's motion along a principal path. Although latitude in degrees north or south of the Earth's equator and longitude in degrees west of the Greenwich prime meridian are the positional units conventionally output by GPS modules, other positional units can be provided. The current location provided by GPS modules in units of the Universal Transverse Mercator (UTM) coordinate system, which is a grid-based method of specifying locations on the surface of the Earth. Another positional unit that can be provided by a GPS module is in the Military Grid Reference System (MGRS), which is the geographic standard used by NATO militaries for locating any point on the earth with a 2 to 10 character geocode. The navigation device can include a map buffer for storing map display data, including cartographic information for the current position. The navigation device can include a visual display for presenting the map display data occurring within a geographic area represented by a navigator viewport of the visual display. The navigation device can also include an audio output for a vocal description of the geographic area represented by a navigator viewport. The navigation device can continuously update the display of the map display data occurring within the geographic area represented by the navigator viewport as the device's motion continues along the principal path. The navigation device can include a processor programmed for computing a database search term as geo-coordinate values of a leading edge of the viewport in the direction of motion, plus an incremental distance in the direction of motion along the principal path. The processor can be programmed for searching the point-of-interest coupon database for new points of interest in a region encompassing or overlapping the incremental distance in the direction of motion and outputting geo-coordinates for the new points of interest and offer/coupon metadata for the new points of interest found in the database. The navigation device can include a coupon buffer for buffering the offer/coupon metadata for the new points of interest. The processor can be programmed for pre-computing driving route instructions for the new points of interest with respect to principal path before the new points of interest come within the geographical area currently covered by the navigator viewport. The processor can be programmed to pre-compute driving route instructions from the principal path to the new point-of-interest, based on the current location of the mobile device and the navigational information in the coupon. The navigation device can include a pre-computed route buffer for storing the pre-computed driving route instructions. The processor can be programmed for displaying icons for the new points-of-interest as they come within the geographical area currently covered by the navigator viewport. The processor can be programmed for receiving a user selection of a new point-of-interest icon being displayed, and in response quickly accessing the corresponding driving route instructions from the pre-computed route buffer that were previously computed with respect to principal path for the selected point-of-interest and presenting the driving route instructions to the user. The processor can also be programmed for accessing and presenting the offer/coupon metadata for the selected point-of-interest.

In another embodiment, the method enables the rapid presentation of promotional coupons along with pre-calculated navigational route instructions for points of interest that are selected by the user in the navigator viewport of the navigation device. The steps of the method include obtaining a current position of the navigation device from a GPS during the device's motion along a principal path. The method continues by accessing a map buffer for displaying map display data for the current position in the navigator viewport and updating the display. The method continues by computing a database search term as geo-coordinates of a leading edge of the viewport in the direction of motion, plus an incremental distance in the direction of motion along principal path. The method continues by searching a point-of-interest coupon database for new points of interest in a region encompassing or overlapping the incremental distance in the direction of motion and outputting geo-coordinates for the new points of interest and offer/coupon metadata for the new points of interest. The method continues by buffering the offer/coupon metadata for the new points of interest in a coupon buffer. The method continues by pre-computing driving route instructions for the new points of interest with respect to principal path before the new points of interest come within the geographical area currently covered by the navigator viewport and storing the driving route instructions in a pre-computed route buffer. The method can pre-compute driving route instructions from the principal path to the new point-of-interest, based on the current location of the mobile device and the navigational information in the coupon. The method continues by obtaining an updated position of the device from GPS during further motion along principal path. The method continues by accessing the map buffer for map display data at the updated position covered by the navigator viewport and updating the display. The method continues by displaying icons for the new points-of-interest as they come within the geographical area currently covered by the navigator viewport. The method continues by receiving a user selection of a new point-of-interest icon being displayed and quickly accessing and presenting driving route instructions previously computed with respect to principal path for the selected point-of-interest and accessing and presenting offer/coupon metadata for the selected point-of-interest.

In another embodiment, a computer program product executable on a digital processor in the navigation device, implements the method embodiment.

In another embodiment, the navigation device can communicate with a remote server that stores information about points of interest. The remote server can include a coupon database for points of interest, for storing offer/coupon metadata accessible by geo-coordinate values for each respective point of interest. The offer/coupon metadata can include promotional coupons and other promotional messages and displayable icons for the point of interest. The navigation device can include a GPS unit for obtaining a current position of the navigation device during the device's motion along a principal path. The navigation device can include a map buffer for storing map display data, including cartographic information for the current position. The navigation device can include a visual display for presenting the map display data occurring within a geographic area represented by a navigator viewport of the visual display. The navigation device can also include an audio output for a vocal description of the geographic area represented by a navigator viewport. The navigation device can continuously update the display of the map display data occurring within the geographic area represented by the navigator viewport as the device's motion continues along the principal path. The navigation device can include a processor programmed for computing a database search term as geo-coordinate values of a leading edge of the viewport in the direction of motion, plus an incremental distance in the direction of motion along the principal path. The processor can be programmed for sending either the geo-coordinates of the device or the search term values to the remote server over a communications medium, to enable the server to search its point-of-interest coupon database for new points of interest in a region encompassing or overlapping the incremental distance in the direction of motion and outputting geo-coordinates for the new points of interest and offer/coupon metadata for the new points of interest found in the database. Any points of interest found by the server during the search will result in offer/coupon metadata for the new points of interest, which is communicated by the remote server to the device over the communications medium. The device then stores the offer/coupon metadata in a coupon buffer. The processor can be programmed for pre-computing driving route instructions with respect to principal path for the new points of interest identified by the remote server, before the new points of interest come within the geographical area currently covered by the navigator viewport. The processor can be programmed to pre-compute driving route instructions from the principal path to the new point-of-interest, based on the current location of the mobile device and the navigational information in the coupon. The navigation device can include a pre-computed route buffer for storing the pre-computed driving route instructions. The processor can be programmed for displaying icons for the new points-of-interest as they come within the geographical area currently covered by the navigator viewport. The processor can be programmed for receiving a user selection of a new point-of-interest icon being displayed, and in response quickly accessing the corresponding driving route instructions from the pre-computed route buffer that were previously computed with respect to principal path for the selected point-of-interest and presenting the driving route instructions to the user. The processor can also be programmed for accessing and presenting the offer/coupon metadata for the selected point-of-interest.

The resulting embodiments solve the problem of how to rapidly present driving route instructions to a driver in a fast moving vehicle before the streets that are the subject of the new instructions are passed.

### DESCRIPTION OF THE FIGURES

FIG. 1 shows a navigation device according to one embodiment, located at a first position along a principal path near a first point of interest and later located at a second position along the principal path near a second point of interest.

FIG. 2 is a functional block diagram of the navigation device of FIG. 1.

FIG. 3 illustrates another embodiment of the navigation device of FIG. 1.

FIG. 4 illustrates an embodiment of a navigator viewport of the navigation device of FIG. 1, moving along the principal path near the first point of interest and moving toward the second point of interest.

FIG. 5 is a generalized data flow diagram of an embodiment of a parallel route calculation program for the navigation device of FIG. 1.

FIGS. 6A through 6J show several example embodiments of point of interest coupons.

### DISCUSSION OF EXAMPLE EMBODIMENTS

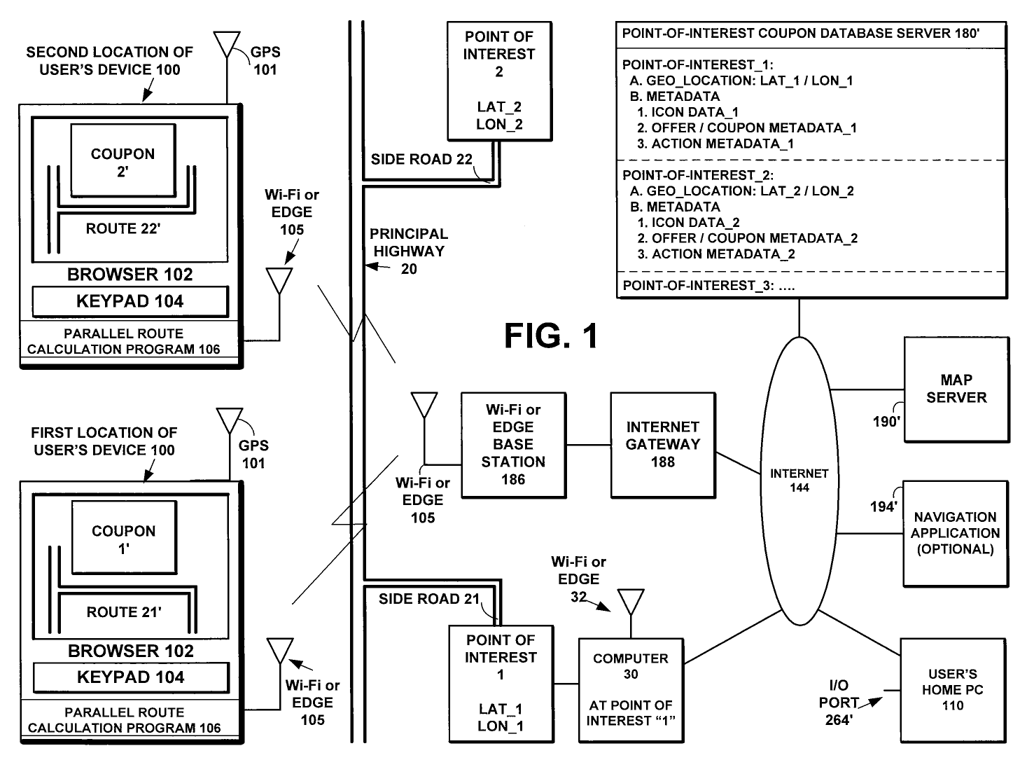

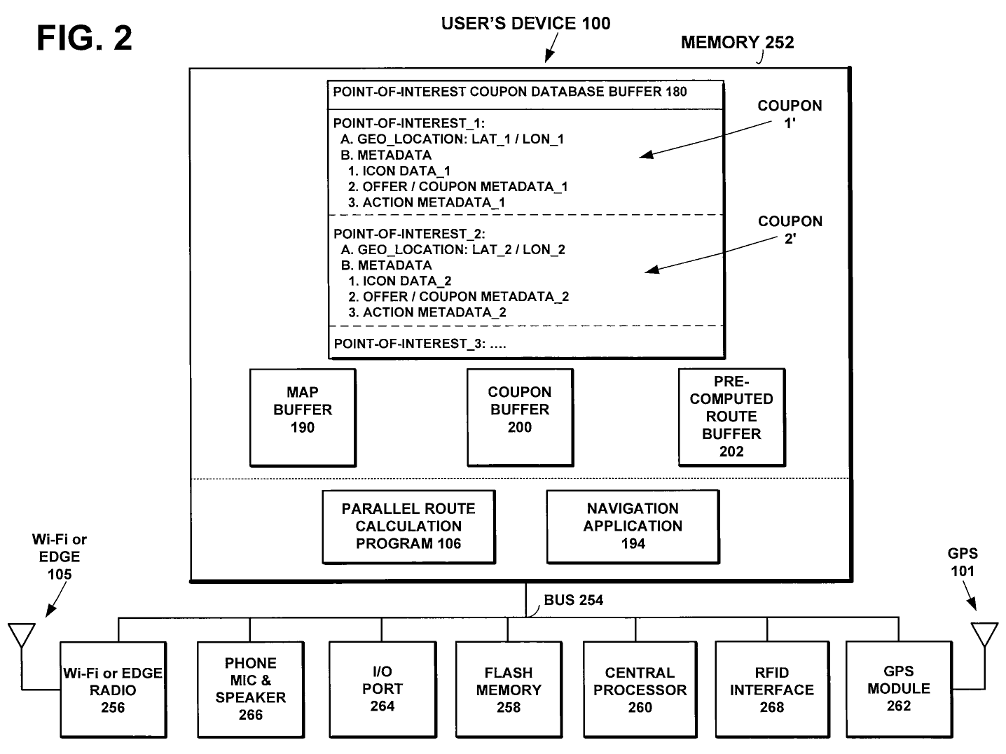

A method, apparatus, and computer program product are disclosed, which solve the problem of how to rapidly present driving route instructions and promotional coupons for points of interest, to a driver in a fast moving vehicle before the streets that are the subject of the new instructions are passed. The method is also useful to a pedestrian carrying a navigator and walking along a street in a shopping center or through a hallway in a shopping mall, who can be provided with the same promotional coupons, similar to the coupons provided to drivers. In one embodiment even though the driver or pedestrian has passed the path leading to the point of interest, the instructions can guide the driver to back to the point of interest location, which may require a longer route, but which will get the driver or pedestrian to the intended point of interest destination. FIG. 1 shows a navigation device 100 according to one embodiment, located at a first position along a principal highway 20 near a first point of interest 1 at a latitude Lat_1 and longitude Lon_1 and later located at a second position along the principal highway 20 near a second point of interest 2 at a latitude Lat_2 and longitude Lon_2. The navigation device 100 can be a part of a cellular telephone or mobile communicator and includes a telephone microphone and speaker 266, as shown in FIG. 2. The navigation device 100 can include a browser 102, a keypad 104, and a parallel route calculation program 106. The keypad 104 can be a touch input user interface. The navigation device 100 can also include a Radio-Frequency Identification (RFID) interface 268.

In an alternate embodiment, the navigation device 100 can be carried by a pedestrian walking along a street in a shopping center or through a main hallway in a shopping mall, which has wireless access points distributed along the length of the street or mall. As the pedestrian walks past a sequence of wireless access points, the position and direction of motion of the pedestrian are determined by the device 100 along the street or main hallway of the shopping mall. The pedestrian can then be provided with the promotional coupons containing walking directions to a new point of interest located farther along the street or hallway beyond the current position of the pedestrian, in the direction of motion. Promotional information and coupons can then be provided by the device 100, which can be redeemed at the new point of interest.

The navigation device 100 of FIG. 1, pre-calculates navigational routes, such as route 22′ over side road 22, to points of interest, such as point of interest 2, on a digital map so that route directions to the selected point of interest can be presented immediately in the browser 102 when the user makes the selection with the keypad 104 while in motion along the principal highway 20. In parallel with motion along the principal highway 20, the navigation device 100 pre-calculates routes, such as route 22′ over side road 22, to points of interest, such as point of interest 2, before they become visible within a viewport area shown in the browser 102, so that the pre-calculated routes can be presented in the browser 102 immediately if the user selects the point of interest with the keypad 104.

FIG. 2 is a functional block diagram of the navigation device 100 of FIG. 1, showing memory 252 connected by the bus 254 to the flash memory 258, the digital central processor 260, the global positioning system (GPS) module 262 with its antenna 101, and the I/O port 264. The I/O port 264 can be a Bluetooth wireless communications interface, an infrared wireless communications interface, a Universal Serial Bus (USB) cable communications interface, or the like, which enables the user to connect the navigation device 100 to the I/O port 264‘of the user’s home personal computer (PC) 110, shown in FIG. 1, to download data from the PC 110 or to upload data to the PC 110. The data downloaded to the I/O port 264 from the user's PC 110 may be read from a compact disk read-only memory (CDROM) or a digital video disk (DVD) storage medium played on the PC 110. The data downloaded to the I/O port 264 from the user's PC 110 may also be accessed over the Internet 144 from a network server, such as the servers 180′ or 190′ shown in FIG. 1.

A wireless local area network and/or a cellular telephone radio 256, with its antenna 105, can also, optionally, be connected to the bus 254. The wireless local area network radio can be, for example, a Wi-Fi wireless local area network based on the IEEE 802.11b standard, which has a communications range of approximately 100 meters. The cellular telephone radio can be, for example, an Enhanced Data rates for GSM Evolution (EDGE) digital mobile telephone radio, which has a communication range of several kilometers and communicates via a base station 186 with the public switched telephone network (PSTN). As shown in FIG. 1, the base station 186 can be connected through the Internet gateway 188 to the Internet 144. The user can connect the navigation device 100 through the radio 256 to the Internet 144 via the base station 186 and Internet gateway 188, shown in FIG. 1, to download data from network servers 180′, 190′, and/or 194′ or to upload data to the network servers 180′, 190′, and/or 194′, shown in FIG. 1. In one embodiment a coupon can be transmitted through the radio 256 when the navigation device 100 arrives at a certain location identified by a particular cell ID in a cellular telephone network or particular GPS coordinates or a particular access point. The coupon may have the driving directions (route, etc.) embedded in the offer/coupon.

The memory 252 includes a point of interest coupon database buffer 180 for points of interest, for storing offer/coupon metadata accessible by geo-coordinate values for each respective point of interest. The offer/coupon metadata can be downloaded to the I/O port 264 from the user's PC 110 when reading a compact disk read-only memory (CDROM) or a digital video disk (DVD) storage medium played on the PC 110. The offer/coupon metadata can be downloaded to the I/O port 264 from the user's PC 110 by accessing it over the Internet 144 from the point of interest coupon database server 180′, shown in FIG. 1. It can also be downloaded through the radio 256 from the Internet 144 via the base station 186 and Internet gateway 188, shown in FIG. 1. The point of interest coupon database buffer 180 can also be embodied as a disk, optical disk, removable memory device such as a smart card, SIM, WIM, or a semiconductor memory such as RAM, ROM, PROM, etc.

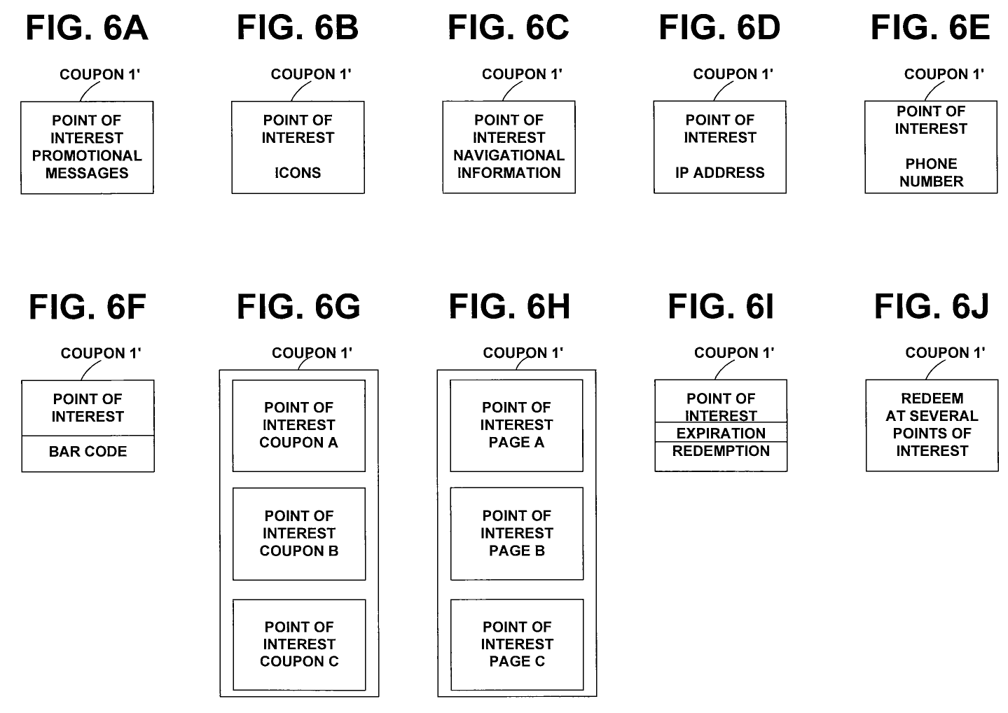

The offer/coupon metadata can include promotional coupons 1′ and 2′, offer data, and other promotional messages as shown in FIG. 6A, navigational information as shown in FIG. 6C, and displayable icons as shown in FIG. 6B for the points of interest 1 and 2, respectively. The navigational information can include, for example, descriptions of two or more alternative routes from the highway to the point of interest, such as a scenic route and a more direct route. The offer/coupon metadata can include the IP address as shown in FIG. 6D or the cellular telephone number as shown in FIG. 6E of the point of interest. As shown in FIG. 1, the point of interest 1 is connected to its own computer 30, which has its own wireless local area network and/or a cellular telephone radio 32, which can be a Wi-Fi or EDGE radio, for example. When the navigation device 100 is within the Wi-Fi communication range of approximately 100 meters to the point of interest 1, the device 100 can use the IP address in the offer/coupon metadata to communicate with the point of interest 1 via it's Wi-Fi radio 32 and computer 30, to redeem a coupon received in the offer/coupon metadata or conduct other commercial transactions with the point of interest 1. In another embodiment, the computer 30 can include a Bluetooth wireless transceiver that can communicate with the Bluetooth-enabled I/O port 264 of the device 100, when the device 100 is within the Bluetooth communication range of approximately 10 meters to the point of interest 1.

In one embodiment, the coupon can be a bar code as shown in FIG. 6F, which can be displayed on the browser 102 of the device 100 and which can be read by a point of sale (POS) terminal at the point of interest. In another embodiment, the redemption of the coupon can occur through a Radio-Frequency Identification (RFID) interface 268 between the device 100 and a POS terminal at the point of interest. In that case, a Near Field Communication (NFC)-enabled device 100 will establish a connection with the POS terminal by emulating the RFID tag and the POS terminal will read the particular offer/coupon data from the tag. The offer/coupon may have an identification (ID), which corresponds to a particular product's ID and if match to the two IDs occurs, then a redemption of the coupon will occur.

In a further embodiment, the offer/coupon may remain on the display during the period when the driver remains near the point of interest. When the driver has left the geographical area of the point-of interest or after the driver has used the offer/coupon, the offer/coupon will be erased from the browser 102, because the geo-coordinates of the device 100 have changed. In this manner, the validity of the offer/coupon has changed to an invalid state. It will be understood that the display and processing of the offer/coupon will not prevent using the mobile telephone functions of the device 100. If, for example, the mobile telephone function of the device 100 receives an incoming call, the image of the offer/coupon on the browser 102 can be moved to a predefined space on the display, for example along the side of the display on the browser 100. In another embodiment, the offer/coupon can be composed of several component offer/coupons, as shown in FIG. 6G, which can be sequentially viewed in the browser 102 by scrolling or clicking through the sequence. In one embodiment, the offer/coupon may be larger than the viewing area of the browser 102, and thus the offer/coupon may be composed of several pages as shown in FIG. 6H that may be viewed sequentially. Each coupon/offer may be linked to the metadata of the coupon/offer, to enable guiding the driver or user to the point of interest being advertised. In one embodiment, the metadata of the offer/coupon may guide the user to a single point-of interest, but in a further embodiment the offers/coupons received may guide to several different points of interest.

In another embodiment, the user can select particular offer/coupons of interest and store the selections in a shopping card area of the memory 252 of device 100, along with storing the expiration date of each particular offer/coupon and whether it has been redeemed as shown in FIG. 6I. If the offer/coupon has expired or has been redeemed, the offer/coupon may be erased from the memory of the device 100. In a further embodiment, the offer/coupon may remain in the memory of the device 100 as long as it has not expired or been redeemed and when the driver passes the point of interest again before the expiration date, the device 100 will once again display the valid offer/coupon. In a further embodiment, the offer/coupon can be selected with a drag-and-drop display function and moved on to the shopping card icon displayed on the browser 102.

Since shops, restaurants, and gas stations are frequently part of a chain of such establishments located along a principal highway 20, the user can exercise or redeem the offer/coupon at any of the establishments in the chain as the user drives along the highway as shown in FIG. 6J. In this embodiment, the selection of offer/coupon updates the driving instructions to each respective establishment in the chain as it is approached along the highway. The selected offer/coupon may also have one or more customized instructions associated with a respective establishment in the chain as it is approached along the highway. In that case, the match between the locations listed in offer/coupon of the respective establishments in the chain and the current location of the device 100, will identify the closest establishment in the chain and the corresponding customized instructions to be displayed to the user.

In a further embodiment, the offer/coupon metadata may comprise a hierarchical menu structure, so that when user selects the offer/coupon, e.g. the advertisement buy jogging shoes at a particular price, the offer/coupon will present a sequence of views on the browser 102 as shown in FIG. 6H. The first view presented by the offer/coupon will show the list of shops where the offer/coupon can be redeemed. The second view will show alternative locations of the shops. The third view will show the street addresses of the locations, with the closest being shown as the default or highlighted option based on the user's current location. The fourth view will show a map with driving instructions, based on the selection in the previous view. In a further embodiment, the views may change smoothly and sequentially after, e.g., 1-3 seconds, depending on preference settings by the user.

In one further embodiment, the offer/coupon has an indication of a key on the keypad of the mobile device. The offer/coupon may be shown as a number in the viewport. The number indicates the key of the keypad. When the user clicks/presses/selects the respective key, then the offer/coupon will show metadata to be used to reach the destination and/or offer/coupon details, which can be selectable options.

In one further embodiment the offer/coupon is provided to the user device through e.g. SMS, MMS or as packet data. The offer/coupon may have an interface to communicate with the map application and map application will have an interface to work together with the offer/coupon. The user may, in one embodiment when he finds it useful, drag the offer/coupon from memory of the device on the map application. In the one alternative embodiment, the offer/coupons may be listed in one row or column in the viewport and user can select them either one by one or all in once and drag and drop on the map application. The offer/coupons may be distributed on the map application on their respective location on the viewport. Only those are shown which are currently on the viewport. In one further embodiment, as the location of the user is known to the device and if the match between the location and offer/coupon exists the offer/coupon is activated and the offer/coupon details are accordingly shown in the viewport. In one further embodiment if the match between the location and offer/coupon exists, the respective offer/coupon may be shown differently, e.g. by way of blinking, and that way the user gets an indication of which offer/coupon data is active.

Customer use of the offer/coupons can be used as a market research tool. The advertisers sponsoring the offer/coupons can analyze the usage data of different point of interest offer/coupons to establish profiles for advertising campaigns focused on particular points of interest, based on geo-coordinates and linked with the map data. Thus the advertisement campaign planner can plan an advertising campaign by observing user interface options, such as the number of potential customers per day passing by a particular point of interest, etc., which can be calculated based on the historical data of route calculations/navigation assistance requests, and the respective number of coupon downloads/usage.

When the navigation device 100 is within cellular telephone communication range of the EDGE mobile telephone base station 186, the device 100 can use the cellular telephone number of the point of interest 1 in the offer/coupon metadata to communicate with the point of interest 1 via the base station 186, the Internet gateway 188 and Internet 144, to redeem a coupon received in the offer/coupon metadata or conduct other commercial transactions with the point of interest 1.

The GPS module 262 obtains a current latitude and longitude of the navigation device 100 during the device's motion along the principal highway 20. The GPS module 262 receives highly accurate time reference signals from the GPS satellite navigation system's constellation of orbiting satellites. Although latitude in degrees north or south of the Earth's equator and longitude in degrees west of the Greenwich prime meridian are the positional units conventionally output by GPS modules, other positional units can be provided. The current location provided by GPS modules can in units of the Universal Transverse Mercator (UTM) coordinate system, which is a grid-based method of specifying locations on the surface of the Earth. Another positional unit that can be provided by a GPS module is in the Military Grid Reference System (MGRS), which is the geographic standard used by NATO militaries for locating any point on the earth with a 2 to 10 character geocode. Other location detection techniques can be used, such as triangulation between cellular telephone base stations or recognition of cell IDs in a cellular telephone network. Still another location detection technique is recognition of access point IDs in a wireless network. The navigation device 100 can include a map buffer 190 for storing map display data, including cartographic information for the current latitude and longitude of the navigation device 100. The navigation application 194 in the memory 252 processes the map display data and cartographic information for the current latitude and longitude to render the map display in the browser 102. The user can connect the navigation device 100 through the EDGE mobile telephone radio 256 to the Internet 144 via the base station 186 and Internet gateway 188, shown in FIG. 1, to download map data from the map server 190′. The map data can also be downloaded to the I/O port 264 from the user's PC 110 reading the data from a compact disk read-only memory (CDROM) or a digital video disk (DVD) storage medium. The map buffer 190 can also be embodied as a disk, optical disk, removable memory device such as a smart card, SIM, WIM, or a semiconductor memory such as RAM, ROM, PROM, etc. Optionally, the navigation device 100 can communicate through the EDGE mobile telephone radio 256 to the Internet 144 via the base station 186 and Internet gateway 188, shown in FIG. 1, to the network server 194′ to remotely perform the functions of the navigation application.

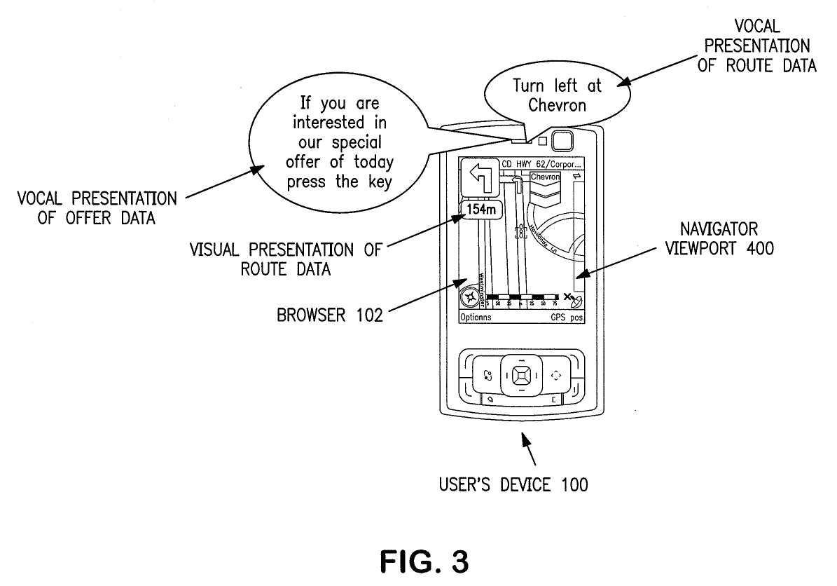

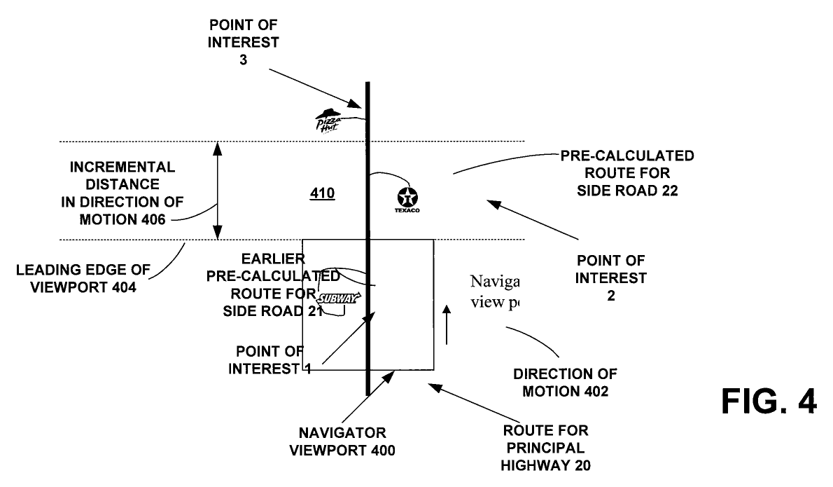

FIG. 3 shows the browser 102 of the device 100 displaying map display data in the viewport 400. FIG. 4 shows the navigator viewport 400 of the navigation device 100, moving in the direction 402 along the principal highway 20 near the first point of interest 1 and moving toward the second point of interest 2. The navigation device 100 browser 102 presents the map display data occurring within a geographic area represented by a navigator viewport 400 shown in FIGS. 3 and 4. The navigation device 100 can also include an audio output for a vocal description of the geographic area represented by a navigator viewport 400, as shown in FIG. 3. The navigation device 100 can continuously update the display of the map display data occurring within the geographic area represented by the navigator viewport 400 as the device's motion 402 continues along the principal highway 20.

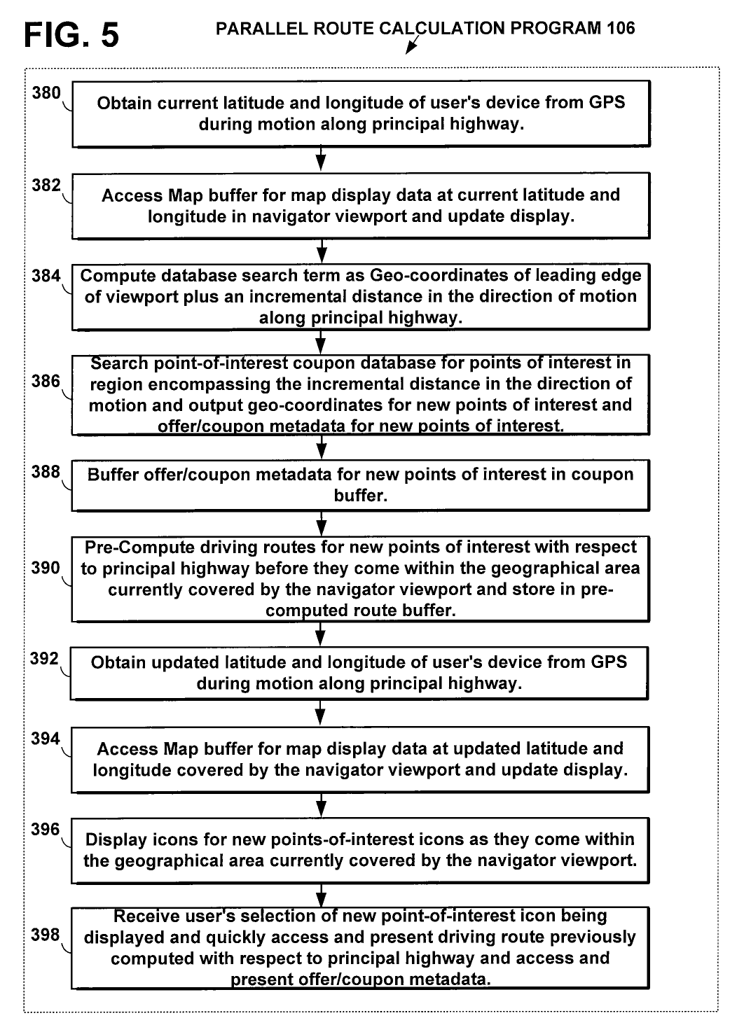

The navigation device can include the processor 260 programmed with the parallel route calculation program 106. FIG. 5 is a generalized data flow diagram of an embodiment of the parallel route calculation program 106 for computing a database search term as geo-coordinate values of the leading edge 404 of the viewport 400 in the direction of motion 402, plus an incremental distance 406 in the direction of motion 402 along the principal highway 20, as shown in FIG. 4. The processor 260 can be programmed with the parallel route calculation program 106 for searching the point-of-interest coupon database 180 for new points of interest in a region 410 encompassing or overlapping the incremental distance 406 in the direction of motion 402 and outputting geo-coordinates Lat_2 and Lon_2 for the new point of interest 2 and offer/coupon metadata for the new point of interest 2 found in the database 180. The navigation device 100 can include a coupon buffer 200 for buffering the offer/coupon metadata for the new points of interest. The processor 260 can be programmed with the parallel route calculation program 106 for pre-computing driving route instructions 22′ for the side road 22 for the new point of interest 2 with respect to principal highway 20, before the new points of interest come within the geographical area currently covered by the navigator viewport 400. The processor can be programmed to pre-compute driving route instructions from the principal path to the new point-of-interest, based on the current location of the mobile device and the navigational information in the coupon.

The navigation device 100 can include a pre-computed route buffer 202 for storing the pre-computed driving route instructions. The processor 260 can be programmed for displaying icons as shown in FIGS. 3 and 4, for the new points-of-interest as they come within the geographical area currently covered by the navigator viewport 400. The processor 260 can be programmed for receiving a user selection from the keypad 104 of a new point-of-interest icon being displayed, and in response quickly accessing the corresponding driving route instructions 22′ from the pre-computed route buffer 202 that were previously computed with respect to principal highway 20 for the side road 22 of the selected point-of-interest 2 and presenting the driving route instructions 22′ in the browser 102 to the user. The processor 260 can also be programmed for accessing and presenting the coupon 2′ in the offer/coupon metadata for the selected point-of-interest 2. FIG. 4 shows the device 100 presenting both visual and vocal offer data and route data.

The resulting apparatus solves the problem of how to rapidly present driving route instructions to a driver in a fast moving vehicle before the streets that are the subject of the new instructions are passed.

FIG. 5 is a generalized data flow diagram of an embodiment of the parallel route calculation program 106 for the navigation device 100 of FIG. 1, which is executable on the digital processor 260 in the navigation device 100, to implement the method embodiment. The program 106 is a sequence of executable instructions that, when executed by the processor 260, carries out the steps shown in the flow diagram of FIG. 5. The program 106 and method enable the rapid presentation of promotional coupons 2′ along with pre-calculated navigational route instructions 22′ for points of interest 2 that are selected by the user in the navigator viewport 400 of the navigation device 100.

In Step 380, the method includes obtaining a current latitude and longitude of the navigation device from a GPS during the device's motion along a principal path.

In Step 382, the method continues by accessing a map buffer for displaying map display data for the current latitude and longitude in the navigator viewport and updating the display.

In Step 384, the method continues by computing a database search term as geo-coordinates of a leading edge of the viewport in the direction of motion, plus an incremental distance in the direction of motion along principal path.

In Step 386, the method continues by searching a point-of-interest coupon database for new points of interest in a region encompassing or overlapping the incremental distance in the direction of motion and outputting geo-coordinates for the new points of interest and offer/coupon metadata for the new points of interest.

In Step 388, the method continues by buffering the offer/coupon metadata for the new points of interest in a coupon buffer.

In Step 390, the method continues by pre-computing driving route instructions for the new points of interest with respect to principal path before the new points of interest come within the geographical area currently covered by the navigator viewport and storing the driving route instructions in a pre-computed route buffer. The method can pre-compute driving route instructions from the principal path to the new point-of-interest, based on the current location of the mobile device and the navigational information in the coupon.

In Step 392, the method continues by obtaining an updated latitude and longitude of the device from GPS during further motion along principal path.

In Step 394, the method continues by accessing the map buffer for map display data at the updated latitude and longitude covered by the navigator viewport and updating the display.

In Step 396, the method continues by displaying icons for the new points-of-interest as they come within the geographical area currently covered by the navigator viewport.

In Step 398, the method continues by receiving a user selection of a new point-of-interest icon being displayed and quickly accessing and presenting driving route instructions previously computed with respect to principal path for the selected point-of-interest and accessing and presenting offer/coupon metadata for the selected point-of-interest.

The resulting programmed method solves the problem of how to rapidly present driving route instructions to a driver in a fast moving vehicle before the streets that are the subject of the new instructions are passed.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments. As such, the terms “article of manufacture” and “computer program product” as used herein are intended to encompass a computer program that exists permanently or temporarily on any computer-usable medium or in any transmitting medium which transmits such a program.

As indicated above, memory/storage devices include, but are not limited to, disks, optical disks, removable memory devices such as smart cards, SIMs, WIMs, semiconductor memories such as RAM, ROM, PROMS, etc. Transmitting mediums include, but are not limited to, transmissions via wireless communication networks, the Internet, intranets, telephone/modem-based network communication, hard-wired/cabled communication network, satellite communication, and other stationary or mobile network systems/communication links.

Although specific embodiments have been disclosed, a person skilled in the art will understand that changes can be made to the specific embodiments without departing from the spirit and scope of the invention.

What is claimed is:

1. A method, comprising:
obtaining a current location of a mobile device during the device's motion along a direction of a principal path;
accessing a point-of-interest coupon for a new point of interest in a region beyond said current location, the region overlapping an incremental distance in the direction of motion, the coupon including navigational information;
pre-computing navigation route instructions from the principal path to the new point-of-interest, based on said current location of the mobile device and said navigational information in the coupon; and
presenting the pre-computed navigation route instructions to a user.

2. The method of claim 1, wherein said coupon includes promotional messages for the point of interest.

3. The method of claim 1, wherein said coupon includes displayable icons for the points of interest, displayable on a display screen of the mobile device.

4. The method of claim 1, wherein said navigational information includes descriptions of two or more alternative routes from the principal path to the point of interest.

5. The method of claim 1, wherein said coupon includes an IP address or cellular telephone number of the point of interest to enable to communication with the point of interest.

6. The method of claim 1, wherein said coupon includes a bar code, which can be displayed on a display screen of the mobile device and be read by a point of sale terminal at the point of interest.

7. The method of claim 1, wherein redemption of the coupon occurs between a Radio-Frequency Identification (RFID) interface of the mobile device and a point of sale terminal at the point of interest.

8. The method of claim 1, wherein the coupon remains displayed on a display screen of the mobile device while the mobile device remains near the point of interest, and when the mobile device moves away from the point-of interest or after the coupon has been redeemed, the coupon is removed from the display screen.

9. The method of claim 1, wherein the coupon is composed of a plurality of component coupons, which are sequentially displayed on a display screen of the mobile device by scrolling through the sequence.

10. The method of claim 1, wherein the coupon is composed of a plurality of pages that are displayed sequentially on a display screen of the mobile device.

11. The method of claim 1, wherein the coupon includes expiration date information and information on whether the coupon has been redeemed at the point of interest.

12. The method of claim 1, wherein the coupon includes information on whether the coupon has been redeemed at the point of interest and if it has been redeemed, coupon is removed from display on a display screen of the mobile device.

13. The method of claim 1, wherein the coupon remains stored in a memory of the mobile device as long as the coupon has not expired or been redeemed at the point of interest and when the mobile device moves near the point of interest before an expiration date of the coupon, the coupon is displayed on a display screen of the mobile device.

14. The method of claim 1, wherein the coupon is redeemable any of a plurality of points of interest in a chain of points of interest.

15. The method of claim 1, wherein the coupon is redeemable any of a plurality of points of interest in a chain of points of interest and the mobile device updates driving instructions to each respective point of interest in the chain as it is approached along the principal path.

16. The method of claim 1, wherein the coupon is displayed on a display screen of the mobile device in a sequence of interactive views, with a first view presented by the coupon showing a list of business establishments where the coupon can be redeemed, a second view showing locations of said business establishments, a third view showing street addresses of the locations, and a fourth view showing a map with driving instructions.

18. The method of claim 1, wherein the coupon is accessed by the mobile device when it arrives at a predefined location identified by a particular cell ID in a cellular telephone network.

19. The method of claim 1, wherein the coupon is accessed by the mobile device when it arrives at a predefined location identified by particular GPS coordinates.

20. The method of claim 1, wherein the coupon is accessed by the mobile device when it arrives at a predefined location identified by a particular access point in a wireless communications network.

21. An apparatus, comprising:
a location detector for determining a current location of a mobile device during the device's motion along a direction of a principal path;
a processor for accessing a point-of-interest coupon for a new point of interest in a region beyond said current location, the region overlapping an incremental distance in the direction of motion, the coupon including navigational information;
said processor pre-computing navigation route instructions from the principal path to the new point-of-interest, based on said current location of the mobile device and said navigational information in the coupon; and
a user presentation device coupled to the processor, for presenting the pre-computed navigation route instructions to a user.

22. The apparatus of claim 21, which further comprises:
a Radio-Frequency Identification (RFID) interface on the mobile device to communicate with a point of sale terminal at the point of interest, to enable redemption of the coupon.

23. The apparatus of claim 21, which further comprises:
a memory coupled to the processor, for storing the coupon as long as the coupon has not expired or been redeemed at the point of interest;
a display device coupled to said memory, for displaying the coupon when the mobile device moves near the point of interest before an expiration date of the coupon.

24. The apparatus of claim 21, wherein said location detector is a GPS detector.

25. The apparatus of claim 21, wherein said location detector uses triangulation between cellular telephone base stations.

26. The apparatus of claim 21, wherein said location detector uses recognition of cell IDs in a cellular telephone network.

27. The apparatus of claim 21, wherein said location detector uses recognition of access point IDs in a wireless network.

28. The apparatus of claim 21, wherein said user presentation device further comprises:
a display for displaying map display data for a current position in a viewport of the mobile device.

29. The apparatus of claim 28, wherein said display presents icons for the new points-of-interest as they come within a geographical area currently covered by the viewport.

30. The apparatus of claim 29, which further comprises:
a user input device coupled to the processor, for receiving a user selection of a new point-of-interest icon being displayed, said display presenting pre-computed navigation route instructions previously computed with respect to the principal path for the selected point-of-interest.

31. A method, comprising:
obtaining a current position of a navigation device during the device's motion along a direction of a principal path;
accessing a map buffer for displaying map display data for the current position in a navigator viewport of the device and updating the display with the map display data;
computing a database search term as geo-coordinates of a leading edge of the viewport in the direction of motion, plus an incremental distance in the direction of motion along the principal path;
searching a point-of-interest coupon database for new points of interest in a region encompassing the incremental distance in the direction of motion and outputting geo-coordinates for the new points of interest;
pre-computing driving route instructions for the new points of interest with respect to the principal path before the new points of interest come within the geographical area currently covered by the navigator viewport;
displaying icons for the new points-of-interest as they come within the geographical area currently covered by the navigator viewport; and
receiving a user selection of a new point-of-interest icon being displayed and presenting pre-computed driving route instructions previously computed with respect to the principal path for the selected point-of-interest.

32. The method of claim 31, wherein the current position of the navigation device are obtained from a GPS during the device's motion along a direction of a principal path.

33. The method of claim 31, wherein the point-of-interest coupon database outputs offer/coupon metadata for the new points of interest in association with the geo-coordinates for the new points of interest.

34. The method of claim 33, further comprising:
buffering the offer/coupon metadata for the new points of interest in a coupon buffer.

35. The method of claim 33, further comprising:
presenting offer/coupon metadata for the selected point-of-interest in response to receiving the user selection of the new point-of-interest icon being displayed.

36. The method of claim 31, further comprising:
storing the driving route instructions in a pre-computed route buffer following said pre-computing step.

37. The method of claim 31, further comprising:
obtaining an updated position of the device during further motion along the principal path following said pre-computing step;
accessing the map buffer for new map display data at the updated position covered by the navigator viewport and updating the display with the new map display data.

38. A method, comprising:
obtaining a current position of a navigation device from a GPS during the device's motion along a direction of a principal path;
accessing a map buffer for displaying map display data for the current position in a navigator viewport of the device and updating the display with the map display data;
computing a database search term as geo-coordinates of a leading edge of the viewport in the direction of motion, plus an incremental distance in the direction of motion along the principal path;
searching a point-of-interest coupon database for new points of interest in a region encompassing the incremental distance in the direction of motion and outputting geo-coordinates for the new points of interest and offer/coupon metadata for the new points of interest;
buffering the offer/coupon metadata for the new points of interest in a coupon buffer;
pre-computing driving route instructions for the new points of interest with respect to the principal path before the new points of interest come within the geographical area currently covered by the navigator viewport and storing the driving route instructions in a pre-computed route buffer;
obtaining an updated position of the device from GPS during further motion along the principal path;
accessing the map buffer for new map display data at the updated position covered by the navigator viewport and updating the display with the new map display data;
displaying icons for the new points-of-interest as they come within the geographical area currently covered by the navigator viewport; and
receiving a user selection of a new point-of-interest icon being displayed and accessing and presenting pre-computed driving route instructions previously computed with respect to the principal path for the selected point-of-interest and accessing and presenting offer/coupon metadata for the selected point-of-interest.

39. An apparatus, comprising:
a coupon database for points of interest, for storing offer/coupon metadata accessible by geo-coordinate values for each respective point of interest;
a location determining device for obtaining a current position during the apparatus' motion along a principal path;
a visual display for presenting map display data occurring within a geographic area represented by a navigator viewport of the visual display;
a processor programmed for computing a database search term as geo-coordinate values of a leading edge of the viewport in a direction of motion, plus an incremental distance in the direction of motion along the principal path;
said processor programmed for searching the point-of-interest coupon database for new points of interest in a region encompassing the incremental distance in the direction of motion and outputting geo-coordinates for the new points of interest and offer/coupon metadata for the new points of interest found in the database;
said processor programmed for pre-computing driving route instructions for the new points of interest with respect to principal path before the new points of interest come within the geographical area currently covered by the navigator viewport;
said processor programmed for displaying icons for the new points-of-interest as they come within the geographical area currently covered by the navigator viewport;
said processor programmed for receiving a user selection of a new point-of-interest icon being displayed, and in response accessing corresponding driving route instructions for the selected point-of-interest, which were previously computed with respect to the principal path, and presenting the driving route instructions to the user; and
said processor programmed for accessing and presenting the offer/coupon metadata for the selected point-of-interest.

40. an apparatus, comprising:
means for obtaining a current location of a mobile device during the device's motion along a direction of a principal path;
means for accessing a point-of-interest coupon for a new point of interest in a region beyond said current location, the region overlapping an incremental distance in the direction of motion, the coupon including navigational information;
means for pre-computing navigation route instructions from the principal path to the new point-of-interest, based on said current location of the mobile device and said navigational information in the coupon; and
means for presenting the pre-computed navigation route instructions to a user.
